(19) United States
(12) Patent Application Publication
(10) Pub. No.: US 2025/0065653 A1
(43) Pub. Date: Feb. 27, 2025

(54) PROCESS PARAMETERS FOR SETTING UP A PRINTING-SYSTEM FOR PRINTING ON A MEDIA

(71) Applicant: Kornit Digital Ltd., Rosh HaAyin (IL)

(72) Inventors: Gerald DAVID, Tel Mond (IL); Arik MOSKOVITZ, Oranit (IL); Efraim YOHANANI NAFTALI, Rishon-LeZion (IL); David BAKALASH, Hod HaSharon (IL); Roy KLEIN, Tel Aviv (IL); Jacob MANN, Zoran (IL)

(73) Assignee: Kornit Digital Ltd., Rosh HaAyin (IL)

(21) Appl. No.: 18/724,655

(22) PCT Filed: Dec. 13, 2022
(86) PCT No.: PCT/IL2022/051320

§ 371 Date: Jun. 27, 2024

Related U.S. Application Data
(60) Provisional application No. 63/293,883, filed on Dec. 27, 2021.

(51) Int. Cl. B41J 29/00; B41J 3/407; G05B 13/02

(52) U.S. Cl. CPC B41J 29/00; B41J 3/4078; G05B 13/0265

(57) ABSTRACT

There is provided a computer implemented method of setting up a target printing system for printing on a target media, comprising: providing a dataset of a plurality of records, wherein a record comprises: (i) at least one sample media parameter of a sample media for processing and/or printing thereon by a sample printing system, (ii) an indication of a quality of a processing and/or a printing by the sample printing system set up with at least one sample process parameter, and (iii) a label indicating the at least one sample process parameter, assigning using the dataset, a combination of a target quality and at least one target media parameter, to at least one target process parameter, and providing the at least one target process parameter predicted to obtain the target quality, for generating instructions for processing and/or printing on the target media by the target printing system.

### RELATED APPLICATION

This application claims the benefit of priority of U.S. Provisional Patent Application No. 63/293,883 filed on Dec. 27, 2021, the contents of which are incorporated herein by reference in their entirety.

### BACKGROUND

The present invention, in some embodiments thereof, relates to printing-systems for printing on a media and, more specifically, but not exclusively, to obtaining process parameters for setting up a printing-system for printing on the media.

Specialized printing-systems are designed to print on special media which may be made of a variety of different materials with different properties, for example, shirts, ceramic mugs, and plastic. Setting up a specialized printing-system for high quality printing on such special media involves correctly setting multiple process parameters.

### SUMMARY

According to a first aspect, a computer implemented method of setting up a target printing system for printing on a target media, comprises: providing a dataset of a plurality of records, wherein a record comprises: (i) at least one sample media parameter of a sample media for processing and/or printing thereon by a sample printing system, (ii) an indication of a quality of a processing and/or a printing by the sample printing system set up with at least one sample process parameter, and (iii) a label indicating the at least one sample process parameter, assigning using the dataset, a combination of a target quality and at least one target media parameter, to at least one target process parameter, and providing the at least one target process parameter predicted to obtain the target quality, for generating instructions for processing and/or printing on the target media by the target printing system.

According to a second aspect, a system for setting up a target printing system for printing on a target media, comprises: a server in network connection with a plurality of printers, the server comprising at least one hardware processor executing a code for: accessing at least one target media parameter associated with a target printer of the plurality of printers, assigning a combination of a target quality and at least one target media parameter, to a plurality of target process parameters, using a dataset comprising a plurality of records obtained from a plurality of sample printers, wherein a record comprises: (i) at least one sample media parameter of a sample media for processing and printing thereon by a sample printing system, (ii) an indication of a quality of a processing and a printing by the sample printing system set up with a plurality of sample process parameters, and (iii) a label indicating the plurality of sample process parameters, and providing the plurality of target process parameters predicted to obtain the target quality, for generating instructions for processing and printing on the target media by the target printing system.

According to a third aspect, a computer implemented method of training a machine learning model for generating a plurality of target process parameters for setting up a target printing system for printing on a target media, comprises, creating a dataset of a plurality of records, wherein a record comprises: (i) at least one sample media parameter of a sample media for processing and printing thereon by a sample printing system, (ii) an indication of a quality of a processing and a printing by the sample printing system set up with a plurality of sample process parameters, and (iii) a ground label indicating the plurality of sample process parameters, training the machine learning model on the dataset for receiving an input of a combination of a target quality and at least one target media parameter, and generating an outcome of the plurality of target process parameters predicted to obtain the target quality, wherein instructions are generated for processing and printing on the target media by the target printing system set up using the plurality of target process parameters.

In a further implementation form of the first, second, and third aspects, the printing system includes a combination of a printer and at least one of a loader mechanism that loads media into the printer and/or an unloader mechanism that unloads media from the printer and/or a drying system and/or folding and/or packing system, wherein the target process parameters include a combination of a plurality of printer parameters for setting up the printer, and at least one of loading parameters for setting up the loader mechanism and unloading parameters for unloading the unloading mechanism.

In a further implementation form of the first, second, and third aspects, the target media comprises textile, and the at least one target media parameter comprises at least one property of the textile.

In a further implementation form of the first, second, and third aspects, the at least one property of the textile is selected from a group comprising: garment, fabric, t-shirt, hat, hoodie, shoe, upper part of shoe, and roll.

In a further implementation form of the first, second, and third aspects, further comprising: creating a new record comprising: (i) at least one actual media parameter of actual media printed thereon by an actual printing system, (ii) the indication of the actual quality of the actual media processed and printed thereon by the actual printing system setup with the at least one actual process parameter, and (iii) the label indicating the at least one actual process parameter, adding the new record to the dataset to create an updated dataset, and using the updated dataset for performing the assigning for new media parameters.

In a further implementation form of the first, second, and third aspects, the actual process parameters of the new record, used to set up the actual printing system, are obtained by using the printing dataset for mapping the combination of a certain quality and the actual media parameters.

In a further implementation form of the first, second, and third aspects, the target quality is at least one of: provided by a user, automatically selected as a highest quality, a default fixed value, provided as metadata, and implied but not explicitly provided.

In a further implementation form of the first, second, and third aspects, further comprising: when the at least one target process parameter is associated with a predicted quality below a threshold, adapting the at least one target process parameter for predicting an increase in the target quality associated with the adapted at least one target process parameter to above the threshold.

In a further implementation form of the first, second, and third aspects, further comprising: analyzing the dataset for computing correlations between media parameters and quality, identifying most significant media parameters that most impact target quality, and generating instructions for suggesting an adaptation to the at least one target media parameter corresponding to the identified most significant media parameters for improving the target quality.

In a further implementation form of the first, second, and third aspects, further comprising: analyzing the dataset for computing correlations between process parameters and quality, identifying most significant process parameters that most impact target quality, and generating instructions for suggesting an adaptation to the process parameters corresponding to the identified most significant process parameters for improving the target quality.

In a further implementation form of the first, second, and third aspects, the plurality of sample process parameters of records of the dataset comprise at least one hardware parameter of the sample printing system, and the at least one target process parameters comprise at least one hardware parameter of the target printing system, and further comprising: when the at least one hardware parameter of the target printing system is different from the at least one hardware parameter of the sample printing system, generating the at least one target process parameters from the plurality of sample process parameters according to at least one of a calibration function and/or a conversion function, between hardware of the target printing system and hardware of the sample printing system.

In a further implementation form of the first, second, and third aspects, at least one of: (i) the media parameter, and (ii) the quality, obtained by implementing the target process parameters, are automatically measured by at least one sensor associated with the target printing system, wherein the at least one sensor measures at least one of: thickness of the media, flatness of media, number and/or height of wrinkles, false loading and/or unloading procedure, bleeding of the print on the media, and false drying and/or curing process.

In a further implementation form of the first, second, and third aspects, assigning comprises at least one of: (i) feeding the combination of the target quality and the at least one target media parameter into a machine learning model training on the dataset, wherein the label of the dataset comprises a ground truth label, and (ii) computing a shortest Euclidean distance within a multidimensional space, between a point represented by the target quality and the at least one target media parameter and a nearest point denoting a certain record of the plurality of records, wherein the at least one target process parameters are of the nearest point.

In a further implementation form of the first, second, and third aspects, the at least one target media parameter and the at least one sample media parameter are selected from a group comprising: chemistry, physical properties, absorption of ink, pretreatment, post treatment, topography, woven or non-woven, weaving pattern, knitting pattern, type, width, material, physical dimensions, thickness, stretchability, manufacturer.

In a further implementation form of the first, second, and third aspects, the at least one target process parameter and the at least one sample process parameter are selected from a group comprising: physical printer setup, pallet automation for automatic selection of a type of pallet, print height, logical printer setup, pre-treatment, print speed, print resolution, and white underbase, drier temperature, drying duration.

In a further implementation form of the first, second, and third aspects, the at least one target media parameter comprises a unique identifier, assigning comprises matching the unique identifier of the at least one target media parameter with a unique identifier of the at least one sample media parameter, and when no match is found between the unique identifier of the at least one target media parameter and the unique identifier of the at least one sample media parameter, assigning comprises identifying at least one sample media parameter that is statistically similar to the at least one target media.

In a further implementation form of the first, second, and third aspects, the label of the record of the dataset is for a specific media type, wherein assigning comprises assigning the combination of the target quality and the at least one target media parameter indicating a requested print job to the specific media type, and providing further comprises providing the specific media type for printing the requested print job.

In a further implementation form of the third aspect, further comprising, performing at least one iteration of: feeding a certain combination of a certain quality and a certain plurality of media parameters of a certain media, obtaining an outcome of the plurality of process parameters, creating at least one variation of the outcome by adapting at least one of the plurality of process parameters, printing and processing a plurality of printed samples of the certain media, each printed sample is printed and processed by the printing system set up respectively with the at least one variation of the outcome, or by a plurality of printing systems set up with respective variations, assigning a respective indication of quality to each printed sample, creating a plurality of new records, each record including respectively the at least one variation, and respective quality, and using an updated version of the ML model updated with new records during a next iteration.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of a system for obtaining process parameters for setting up a target printing system for printing on a target media using a dataset, in accordance with some embodiments of the present invention;

FIG. 2 is a flowchart of a method of obtaining process parameters for setting up a target printing system for printing on a target media using a dataset, in accordance with some embodiments of the present invention;

FIG. 3 is a block diagram of exemplary components of a printing system, in accordance with some embodiments of the present invention;

FIG. 4 is a schematic depicting an exemplary record of the dataset, in accordance with some embodiments of the present invention;

FIG. 5 is a flowchart depicting an exemplary process for the case of a new media to be printed on, in accordance with some embodiments of the present invention;

FIG. 6 is a flowchart depicting an exemplary process for usage and update of records of the dataset, in accordance with some embodiments of the present invention;

FIG. 7 is a dataflow diagram depicting exemplary dataflow for using a dataset for obtaining process parameters and iteratively updating the dataset based on outcomes of the printing, in accordance with some embodiments of the present invention;

FIG. 8 is a schematic depicting exemplary media parameters, in accordance with some embodiments of the present invention;

FIG. 9 is a schematic depicting a process for creation of media, in accordance with some embodiments of the present invention;

FIG. 10 is a tree indicating exemplary media parameters, in accordance with some embodiments of the present invention;

FIG. 11 is a tree indicating exemplary print sections—the images and areas that the current print job is built from, in accordance with some embodiments of the present invention;

FIG. 12 is a tree indicating a fulfilment data model (for each printing system and configuration) indicating exemplary process parameters, in accordance with some embodiments of the present invention;

FIG. 13 is a schematic of a shirt with four different test print runs, for iterative improvement, in accordance with some embodiments of the present invention; and

FIG. 14 is a table of exemplary media parameters, fields, and examples/units, in accordance with some embodiments of the present invention.

### DETAILED DESCRIPTION

The present invention, in some embodiments thereof, relates to printing-systems for printing on a media and, more specifically, but not exclusively, to obtaining process parameters for setting up a printing-system for printing on the media.

An aspect of some embodiments of the present invention relates to systems, methods, devices, and code instructions for providing process parameters for setting up a target printing system for printing on a target media, to obtain a target quality outcome. For example, when setting up for printing on a new type of target media for which the operator of the target printing system does not have sufficient experience yet and is unsure of the correct process parameters. A dataset of records is created, accessed, and/or provided, optionally from multiple different sample printing systems that have been set up with multiple different sample process parameters, that have printed on multiple different sample media, obtaining multiple different quality results. A record includes the following data items: (i) sample media parameter(s) of a sample media for processing and/or printing thereon by a sample printing system, (ii) an indication of a quality of a processing and/or a printing by the sample printing system set up with sample process parameter(s), and (iii) a label indicating the ample process parameter(s). Using the dataset, a combination of the target quality and target media parameter(s) are assigned (e.g., mapped) to target process parameter(s). The target process parameter(s) predicted to obtain the target quality is provided for generating instructions for processing and/or printing on the target media by the target printing system. The instructions may be generated and executed by the target printing system, by processing and/or printing on the target media using the target process parameters.

At least some implementations of the systems, methods, computing devices, and code instructions (i.e., stored on a data storage device and executable by one or more processors) described herein address the technical problem of selecting process parameters of a printing-system for printing on media, in particular fabric and/or other flexible highly absorbent materials prone to wrinkling, for example, garment, hats, shoc, upper part of shoe, and t-shirt. This is in contrast to a standard printing-system printing on standard media that are fairly rigid and not highly absorbent, for example, paper, plastic, wood, and ceramic. Printing on fabric is associated with the additional technical challenge of processing the fabric, in addition to the printing, for example, feeding the fabric into the printer, loading the fabric, and unloading the fabric. The processing of the fabric is significant in obtaining desired printing outcomes, for example, due to potential wrinkling of the fabric, and drying of the printed material-technical challenges that are irrelevant for standard printing on standard media such as paper. For a specific media (e.g., t-shirt or sweatshirt), the specific garment or roll that the media is made from is considered. Now, different media (e.g., t-shirt or sweatshirt) made from the same fabric will have common printer setup relevant to the fabric. However, for a different fabric but the same media (size, kind and style) will use same physical processing setup (e.g., loading, unloading, and the like) but different print setup. Moreover, since each media has different characteristics, for example, material, absorbance, color, width, type, and size, correct selection of the process parameters for printing on the specific media is required to obtain high quality results. However, the wide range of variability in the media that may be printed on, makes correct selection of the process parameters challenging. A different combination of process parameters may be required for each unique media. Each time a new media is used, a new combination of process parameters is to be selected. The technical problem of selecting a specific combination of printing-system process parameters for a specific media arises from the very large number of unique media that may be fed into the printing-system to be printed on. Moreover, the large number of different printing-systems that may be used further increases the technical difficulty of selecting the correct process parameters for a specific printing-system to print on a specific media. No global database contains all media, and no global data format is defined that indicates which process parameters are to be selected for a specific printing-system for printing on a specific media.

For a new media, embodiments described herein will recommend the closest process parameters for setting up the printing system based on known media (e.g., from the manufacturer, such as material, treatment etc.) and known process parameters previously used by other similar printing systems. The closest setup provides an initial setup point for this new setup for the new media. Additional iterations may be performed to obtain higher quality while updating the dataset, as described herein.

At least some implementations of the systems, methods, computing devices, and code instructions described herein address the technical problem of providing corrections to process parameters used by a printing system, when default values do not provide adequate results. For example, the manufacturers of the shirts do not provide sufficient media parameters, and/or the media parameters may be incorrect and/or inconsistent (e.g., for a shirt with same dimensions, some manufacturers refer to it as large, while other manufacturers refer to the shirt as small). At least some implementations of the systems, methods, computing devices, and code instructions described herein improve the technical field of printing systems. The technical problems is addressed, and/or the technical improvement is based on, iterative feedback provided by actual printing systems, that is used to update records of a dataset that assigns process parameters. The iterative update of the dataset corrects the process parameters based on actual printing results, enabling high quality printing results for different printing systems printing on different media.

Moreover, analysis (e.g., offline) of the records of the dataset enables to manipulate and/or adjust process parameters and/or other data by learning its behavior and/or correlations between the data items, and/or creating a continuous improvement loop where new and/or existing data items influence existing data items, that in turn adjusts the process parameters, such as the printer's physical attributes.

For example, the media height sensor (that also operates as a wrinkle detector in the printers) gives a lot of information regarding the media behavior after being loaded on the pallet, such as the number of wrinkles, media height above the pallet, false loading procedure (either by automatic or manual loader), and more. All that data from all available printing systems, from all attached facilities, is stored in a combined media dataset. By analyzing the complete result arrays in the dataset, a machine learning or other process (e.g., computing correlations) can easily point on specific correlations and/or sensitivity of each media type, and then suggest how to improve the physical attributes. For example, if a specific garment type (e.g., XXL polyester shirt) is loaded multiple times with wrinkles (which can cause faulty print or even stop the printer's operation), the system can automatically adjust the loading parameters, such as gripping, speed, and strength, to improve the process with as many iterations as required. Furthermore, if no parameters provide full success for the loading procedure, the system can also reset the media height limitation to a higher level specifically to the said media.

Closed-loop analysis may rely on the print QC results (indicate the quality of the end-print on the garment before and/or after being dried) or customers returns/grades, or from the printers' feedback (from sensors, errors, etc.) to improve each attribute of the printer: wet pretreatment, heat pretreatment, white under-base, color profiles, etc.

For instant, media that requires many corrections after being loaded should be loaded in a different sequence; media that creates many wrinkles should use higher print head height; etc.

Standard approaches for selecting parameters for a printing-system for printing on a media are based on manual selection of the print process parameters. Manual selection requires a knowledgeable and/or experienced human operator. An iterative trial and error calibration may be employed in which a first set of parameters are manually selected by the operator. A test is printed using the first set of parameters. Another set of parameters is then selected by adjusting the first set of parameters, based on a best manual guess by the operator. The iterative printing and adjustment of the parameters is performed until a desired quality is obtained. The manual iterative calibration raises its own technical problems, such as being time consuming to perform, and/or wasting blanks of the media and/or ink of the printing-system, which creates waste and/or may be costly. Moreover, when a new media is being used, i.e., where the system or the operator has not previously used the same media in the past, multiple iterations may be needed to find the correct parameters to obtain high quality printing on the new media.

Other standard approaches for selecting parameters for a printing-system for printing on a media are based on looking up the parameters in a database specific to each manufacturer. However, manufacturers do not necessarily provide parameters for each type of media, and surely not the all needed parameters required by the printer, mainly due to the very large number of media that may be used. For a new media which is not in the manufacturer or the printers' database, a default setup value may be used for the parameter. For example, 100% cotton, polyester, 50-50 blends, and the like. The default values are not expected to result in high quality prints, but rather to serve as a starting point for the trial and error iterative process of adjusting the default values in an attempt to find the parameters that obtain high quality prints on the new media.

New parameters for new media may be manually added by each manufacturer to their own database. Such manual updates are slow, incomplete, and error prone.

At least some implementations of the systems, methods, computing devices, and code instructions described herein provide a technical solution to the above mentioned technical problem, and/or improve the technical field of printing-systems for high quality printing on media, in particular non-paper media such as textile and/or fabric. The technical solution and/or improvement to the technical field is based on the dataset that is used to assign (e.g., map) target media parameters of a target media to target process parameters which are used to set up a target printing-system for processing the target media (e.g., loading, unloading) and for printing on the target media. The dataset is created by aggregating data from a single or multiple different printing-systems printing on a single or multiple different media using different process parameters, optionally at different quality levels. The dataset maps to the closest process parameters, which may be of a similar but different printing-system and/or similar but different media. Using the dataset to obtain the target process parameters enabling high quality outcomes of the printing on the media and/or of the processing of the media, during a first attempt or reduced number of calibration iterations in comparison to manual approaches. In at least one implementation the different optional parameters are being printed as multiple samples on the same media (i.e. 3×3 squares), each square with different parameters.

At least some implementations of the systems, methods, computing devices, and code instructions described herein improve the technology of printing systems, by providing a unified dataset for the media (e.g., blank garments and/or rolls of fabric) on which printing systems process and/or print, using data from several sources. The data may be optimized in multiple iterations (e.g., continuously), for example, through closed loop interactions with the printing systems and/or within the dataset itself, to achieve the upmost quality prints from combinations of a certain printing system and a certain media, by selecting the most suitable process parameter(s) for each media according to the printing system that is predicted to obtain high quality outcomes. An optional cloud-based system may utilize aggregated actual print data results to provide printing and/or processing instructions to a non-familiar substrate blank (e.g., T-Shirt, Hat, Hoodic, Roll, Shoe, Upper part of shoc) based on aggregates data from several sources. Using the same data allows different operations (e.g., manufacturers) with different printing systems to make an informed purchase decision on which blank type works best with their equipment, by grading the media using the aggregated QC results and required quality level.

At least some implementations of the systems, methods, computing devices, and code instructions described herein improve the technology of printing systems, by enable printing systems' operators (e.g., manufacturers) to achieve high quality prints in any printing system with any media, optionally any textile media (e.g., blank garments and/or fabric rolls), with minimum interference and time, by creating and/or using a centralized and global dataset with known media and printing systems, optionally combined with continuous automatic updating and/or optimization processes. Operators are provided with the knowledge of how to print with a high quality on a blank which was never used/calibrated at the specific printing system. As described herein, this may be done by input of the known data of the new media (e.g., color, material, manufacturer—that might be using specific post treatment to the media, size etc.), and knowing the calibration and/or conversion between different printing systems (e.g., each printing system family has its own characteristics such as ink type, pre-treatment type, printing mode etc.) The process parameters to use for the printing system are derived automatically using the dataset, from other printing systems which may have been using the same blank media.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

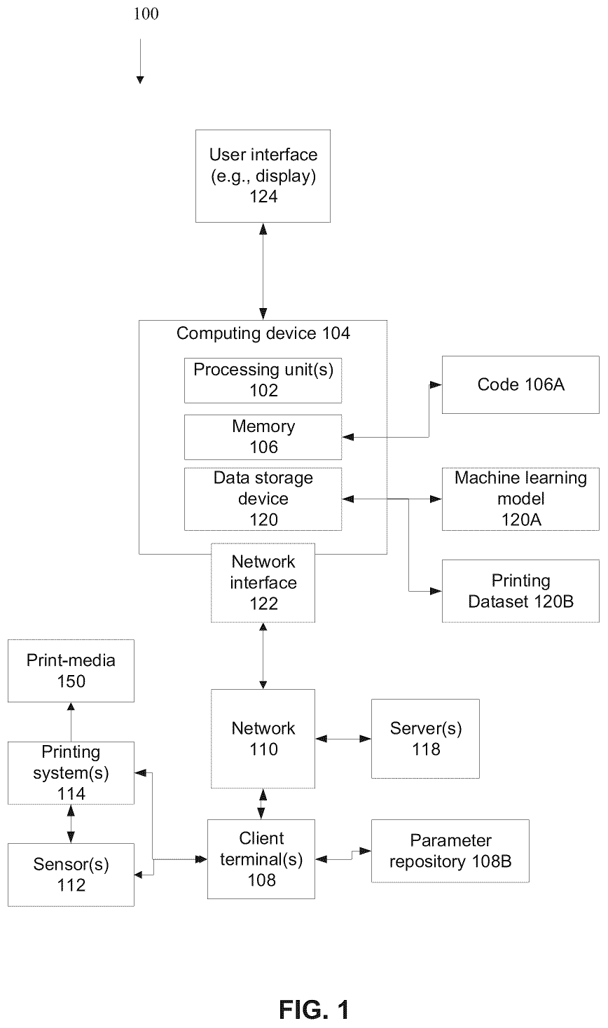

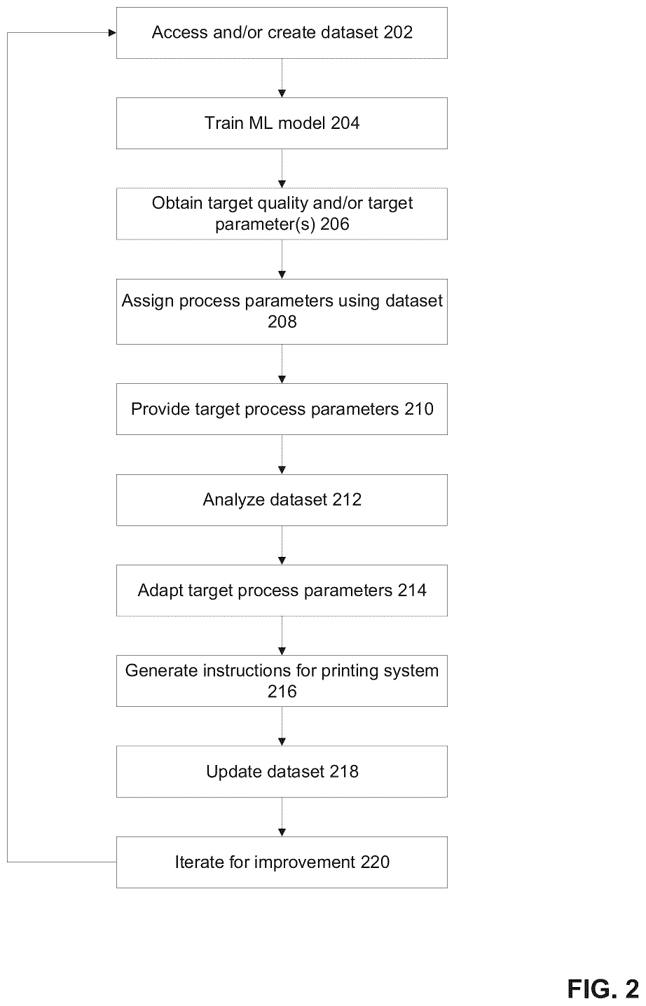

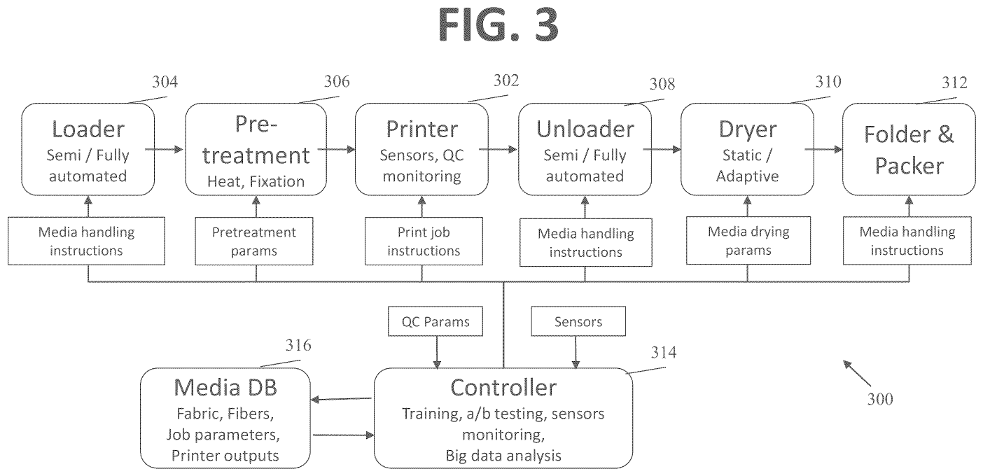

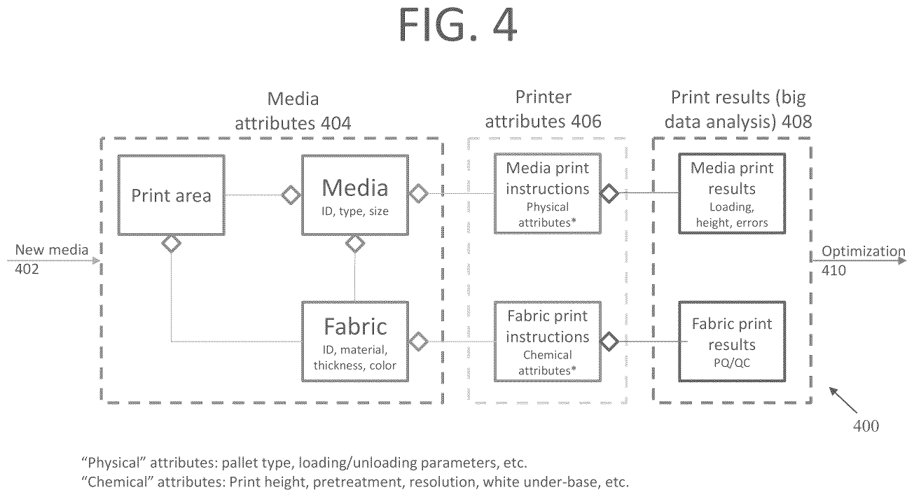

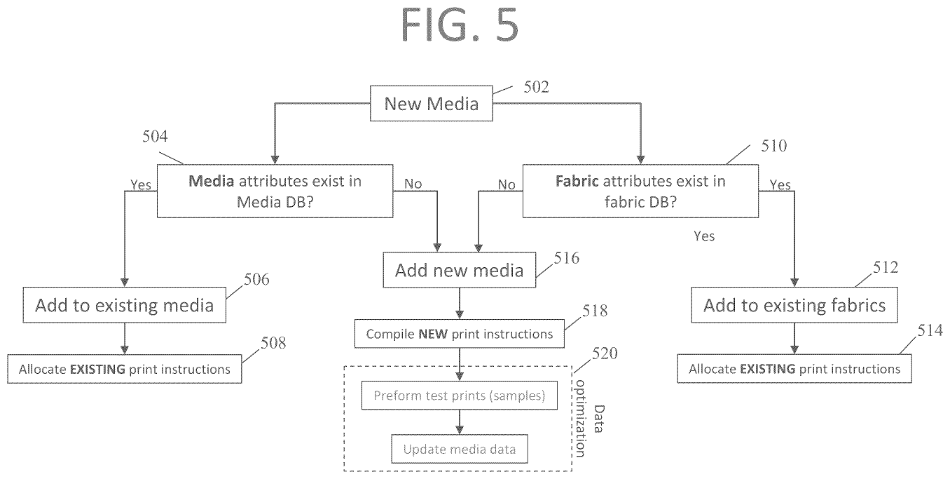

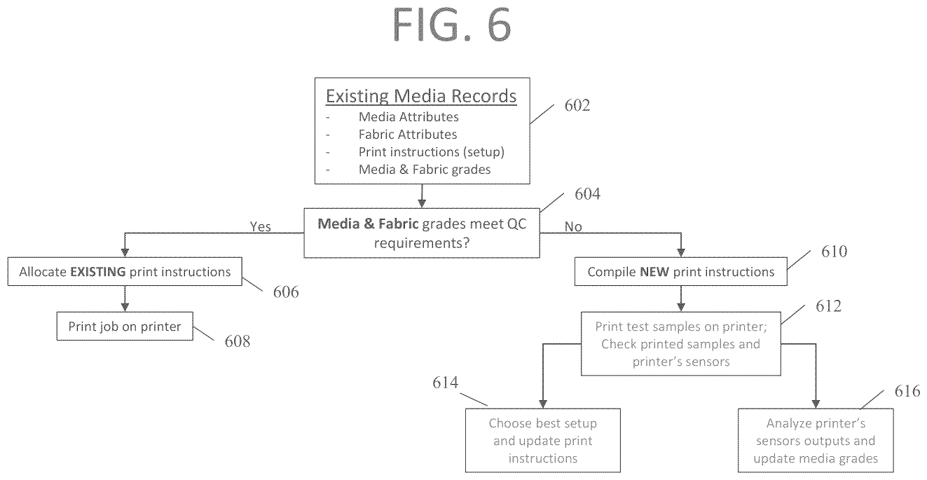

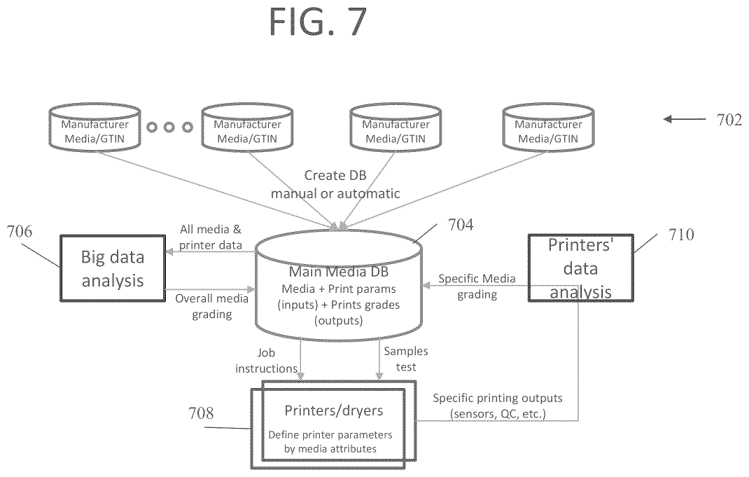

Reference is now made to FIG. 1, which is a block diagram of a system 100 for obtaining process parameters for setting up a target printing system for printing on a target media using a dataset, in accordance with some embodiments of the present invention. Reference is also made to FIG. 2, which is a flowchart of a method of obtaining process parameters for setting up a target printing system for printing on a target media using a dataset, in accordance with some embodiments of the present invention. Reference is also made to FIG. 3, which is a block diagram of exemplary components of a printing system, in accordance with some embodiments of the present invention. Reference is also made to FIG. 4, which is a schematic depicting an exemplary record of the dataset, in accordance with some embodiments of the present invention. Reference is also made to FIG. 5, which is a flowchart depicting an exemplary process for the case of a new media to be printed on, in accordance with some embodiments of the present invention. Reference is also made to FIG. 6, which is a flowchart depicting an exemplary process for usage and update of records of the dataset, in accordance with some embodiments of the present invention. Reference is also made to FIG. 7, which is a dataflow diagram depicting exemplary dataflow for using a dataset for obtaining process parameters and iteratively updating the dataset based on outcomes of the printing, in accordance with some embodiments of the present invention.

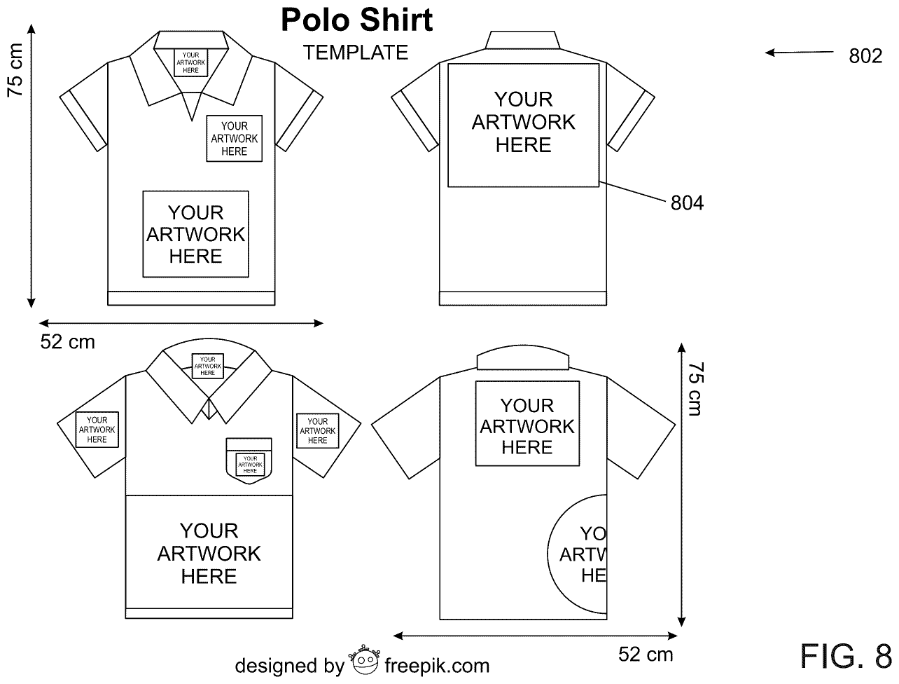

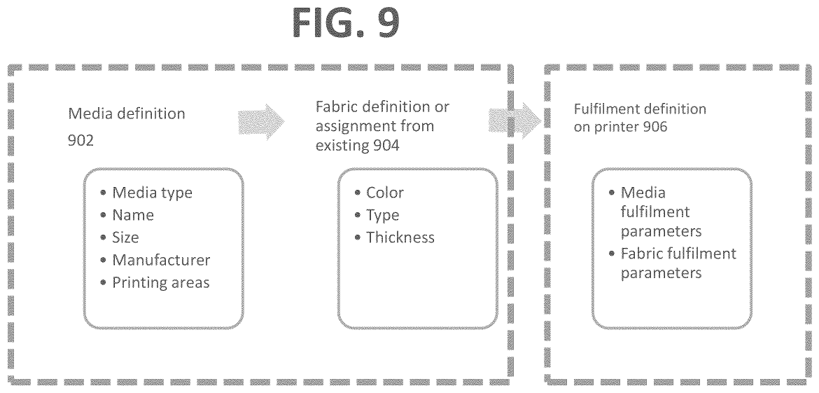

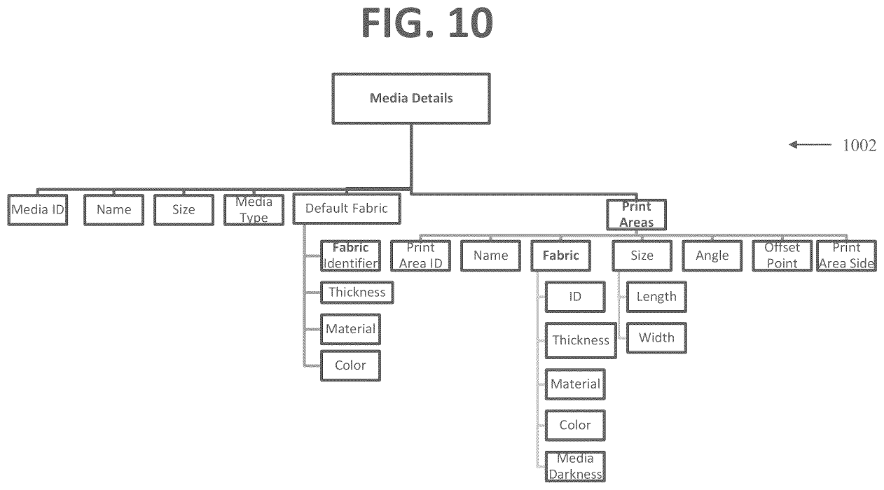

Reference is also made to FIG. 8, which is a schematic depicting exemplary media parameters, in accordance with some embodiments of the present invention. Reference is also made to FIG. 9, which is a schematic depicting a process for creation of media, in accordance with some embodiments of the present invention. Reference is also made to FIG. 10, which is a tree indicating exemplary media parameters, in accordance with some embodiments of the present invention.

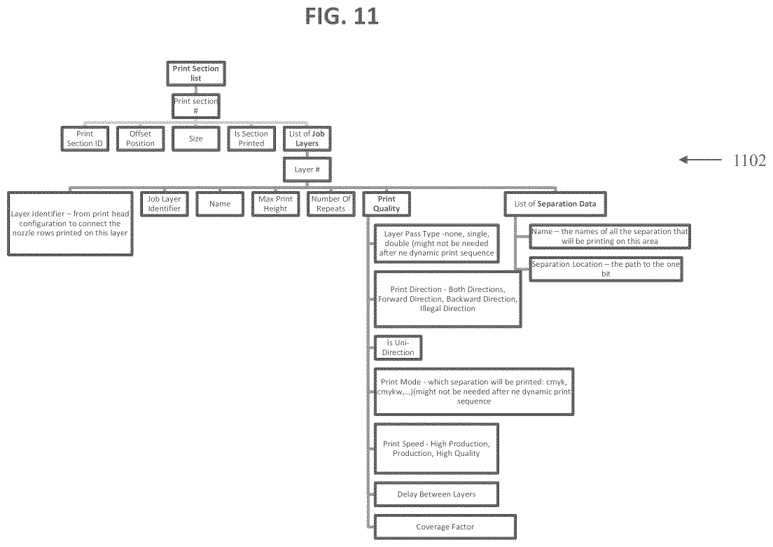

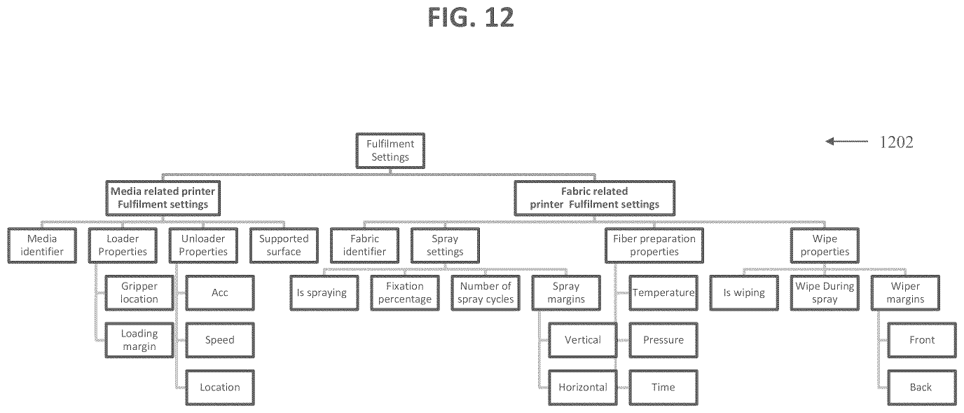

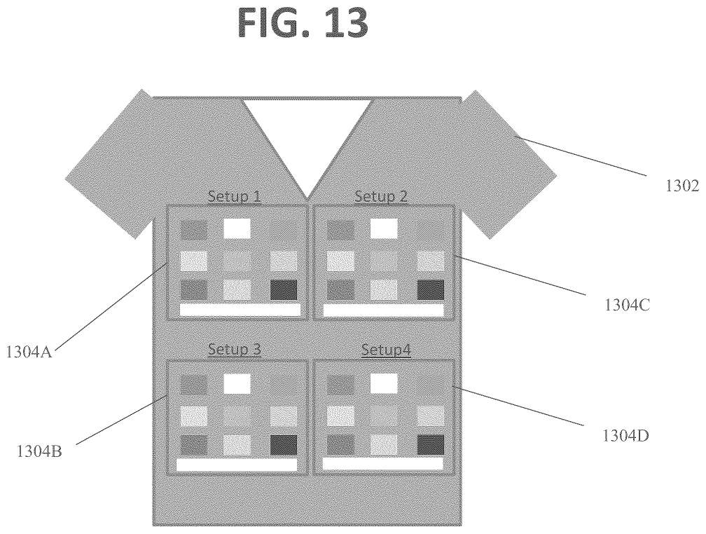

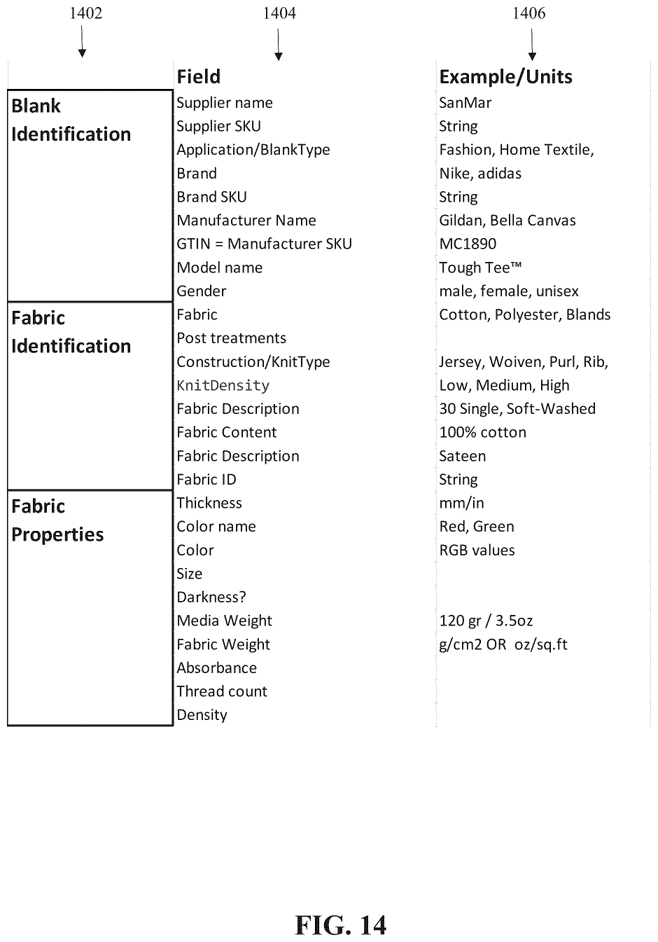

Reference is also made to FIG. 11, which is a tree indicating exemplary print sections—the images and areas that the current print job is built from, in accordance with some embodiments of the present invention. Reference is also made to FIG. 12, which is a tree indicating a fulfilment data model (for each printing system and configuration) indicating exemplary process parameters, in accordance with some embodiments of the present invention. Reference is also made to FIG. 13, which is a schematic of a shirt 1302 with four different test print runs 1304A-D, for iterative improvement, in accordance with some embodiments of the present invention. Reference is also made to FIG. 14, which is a table of exemplary media parameters 1402, fields 1404, and examples/units 1406, in accordance with some embodiments of the present invention.

System 100 may implement the features of the method described with reference to FIGS. 2-14, by one or more hardware processors 102 of a computing device 104 executing code instructions 106A stored in a memory (also referred to as a program store) 106.

Computing device 104 receives media parameters and/or quality and/or process parameters and/or other parameters described herein from one or more of: a specific printing-system 114, sensor(s) 112 associated with a specific printing-system 114, a specific client terminal 108 associated with the specific printing-system 114, and/or from a specific parameter repository 108B associated with the specific printing-system 114.

Optionally, a combination of the quality and media parameter(s) are assigned and/or mapped (e.g., by computing device 104) to one or more process parameter(s) by a dataset 120B, as described herein. The process parameter(s) are provided to the specific printing-system 114 for printing on a media 150, as described herein.

Alternatively or additionally, one or more of media parameters and/or quality and/or process parameters and/or other parameters are used to create new records of dataset 120B, and/or to update values of existing records of dataset 120B, as described herein. Data for creation of new records and/or updating of existing records of dataset 120B may be obtained from multiple different sample printing-systems 114, sample sensor(s) 112 associated with the sample printing-systems 114, from multiple different sample client terminals 108 associated with the sample printing-systems 114, and/or from multiple different sample parameter repositories 108B associated with the different sample printing-systems 114 such as databases of the manufacturers of the media.

Each printing-system 114 prints on a respective media 150. The same printing-system 114 may print on multiple different media 150 and/or print different prints on the same media 150, which requires a selection of a new set of process parameters, by using the dataset 120B, as described herein.

Exemplary media 150 are described herein.

Multiple architectures of system 100 based on computing device 104 may be implemented. In an exemplary implementation, computing device 104 may be implemented as one or more servers (e.g., network server, web server, a computing cloud, a virtual server) that provides services to multiple printing-system(s) 114, for example, providing centralized services to remotely located printing-systems 114. Printing-system(s) 114 may directly communicate with computing device 104 acting as the server over network 110, and/or may indirectly communicate with the server using an intermediary device, such as client terminal 108 (e.g., mobile device, desktop computer, computer integrated within printing-system 114) that locally communicates with printing-system 114 and remotely communicates with the server over network 110.

Alternatively, in a local implementation, computing device 104 may be implemented as a component within printing-system 114, for example, as a controller and/or card and/or circuitry installed within the housing of printing-system 114. In the local implementations, the local computing device 104 may access a locally stored dataset 120B. Dataset 120B may be downloaded from a central server that creates dataset 120B by aggregation of data from multiple different local datasets or printing-systems 114, as described herein. In another example, dataset 120B may be locally created based on data obtained from the local printing-system 114 (e.g., from previous printing sessions) and/or received from other printing-systems.

In another local implementation, computing device 104 may be an external device that is in local communication with printing-system 104, for example, computing device 104 is a mobile device (e.g., smartphone, laptop, watch computed) connected to printing-system 114, for example, by a cable (e.g., USB) and/or short-range wireless connection. In such implementation, each computing device 104 may be associated with a single or small number of printing-systems 114, for example, a user uses their own smartphone to connect to their own printing-system. The computing device 104 may serve as the controller of the printing-system.

Printing-system 114 includes at least a printer, and optionally one or more other components such as an unloader and/or loader, a dryer, as described herein.

Sensor(s) 112 may be installed within printing-system 114, and/or external to printing-system 114 for monitoring printing-system 114. Exemplary sensor(s) 112 include a height sensor for sensing height of the print head above the media, a wrinkle sensor for detecting wrinkles in the media, and quality control (QC) sensor or sensors for sensing quality of the printing process and/or printed media.

Computing device 104 and/or client terminal(s) 108 may be implemented as, for example, a client terminal, a server, a virtual machine, a virtual server, a computing cloud, a mobile device, a desktop computer, a thin client, a Smartphone, a Tablet computer, a laptop computer, a wearable computer, glasses computer, and a watch computer.

Hardware processor(s) 102 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include one or more processors (homogenous or heterogeneous), which may be arranged for parallel processing, as clusters and/or as one or more multi core processing units. Memory 106 stores code instructions executable by hardware processor(s) 102. Exemplary memories 106 include a random-access memory (RAM), read-only memory (ROM), a storage device, non-volatile memory, magnetic media, semiconductor memory devices, hard drive, removable storage, and optical media (e.g., DVD, CD-ROM). For example, memory 106 may store code 106A that execute one or more acts of the method described with reference to FIG. 2-14.

Computing device 104 may include a data storage device 120 for storing data, for example, machine learning model 120A trained on dataset 120B, and/or dataset 120B. Data storage device 120 may be implemented as, for example, a memory, a local hard-drive, a removable storage device, an optical disk, a storage device, and/or as a remote server and/or computing cloud (e.g., accessed over network 110). It is noted that code 120A may be stored in data storage device 120, with executing portions loaded into memory 106 for execution by processor(s) 102.

Computing device 104 may include a network interface 122, for connecting to network 110, for example, one or more of, a wire connection (e.g., physical port), a wireless connection (e.g., antenna), a network interface card, a wireless interface to connect to a wireless network, a physical interface for connecting to a cable for network connectivity, and/or virtual interfaces (e.g., software interface, application programming interface (API), software development kit (SDK), virtual network connection, a virtual interface implemented in software, network communication software providing higher layers of network connectivity).

Network 110 may be implemented as, for example, the internet, a local area network, a virtual network, a wireless network, a cellular network, a local bus, a point-to-point link (e.g., wired), and/or combinations of the aforementioned.

Computing device 104 may communicate with one or more of the following over network 110:
Printing-system(s) 114 to obtain media parameters and/or process parameters and/or quality (for assignment and/or for updating records and/or for creating new records), and/or to provide the printing process parameters assigned using the dataset.
Sensor(s) 112 to obtain process parameters and/or quality.
Client terminal 108 to obtain media parameters and/or process parameters and/or quality (for assignment and/or for updating records and/or for creating new records), and/or to provide the printing process parameters assigned using the dataset.
Parameter repository 108B which may be stored on a data storage device of client terminal 108 and/or on another data storage device, to obtain media parameters and/or process parameters and/or quality (for assignment and/or for updating records and/or for creating new records).
Server(s) 118, for example, to obtain updated versions of code 106A and/or process parameters from parameter repository 108B (e.g., which may be stored on a data storage device of the server). It is noted that training of ML model 120A may be performed by computing device 104, or remotely by server 118 with trained ML model 120A provided to computing device 104.

Computing device 104 may include and/or be in communication with one or more physical user interfaces 124 that include provide a mechanism to enter data (e.g., desired quality) and/or view data (e.g., assigned process parameters) for example, one or more of, a touchscreen, a display, gesture activation devices, a keyboard, a mouse, and voice activated software using speakers and microphone.

Referring now back to FIG. 3, printing system 300 includes a printer 302 and one or more exemplary additional components 304-312 that support the process associated with the printing.

A controller 314 is in communication with printing system 300. Controller 314 may be implemented as the server and/or computing device and/or process described herein, for example, with reference to FIG. 1. Controller 314 may perform features described with reference to FIG. 2, for example, training a machine learning model, iterative (e.g., a/b) testing, sensor monitoring, and big data analysis (e.g., finding and/or computing correlations).

Controller 314 may access a media database 316, also referred to herein as the dataset. Media database 316 includes data of fabrics, fibers, job parameters, and printer output, also referred to herein respectively as media parameters, process parameters, and quality.

Printing system 300 is setup using process parameters obtained from controller 314, by accessing the dataset, as described herein.

A loader mechanism 304 loads the media into the printer. Loader may be semi (that is, with a person in the loop) or fully automatic. Loader 304 receives media handling instructions (of the process parameters) from controller 314. Loader 304 may include sensors which may perform QC monitoring on the process

A pre-treatment mechanism 306 heats and/or performs fixation on the media. Pre-treatment 306 receives pretreatment parameters (of the process parameters) from controller 314. Pretreatment 306 may include sensors which may perform QC monitoring on the process.

Printer 302 prints on the media, for example, by depositing ink or other material, based on print job instructions received from controller 314. Printer 302 may include sensors which may perform QC monitoring on the print results.

An unloader mechanism 308 unloads the media after the printing. Unloader 308 may be semi or fully automatic. Unloader 308 receives media handling instructions (of the process parameters) from controller 314. Unloader 308 may include sensors which may perform QC monitoring on the process.

A dryer 310 dries the media after printing. Dryer 310 may be static or adaptive. Dryer 310 receives media drying parameters (of the process parameters) from controller 314. Dryer 310 may include sensors which may perform QC monitoring on the process.

A folder and packer mechanism 312 folds and/or packs the printed media. Folder and packer 312 receives media handling instructions (of the process parameters) from controller 314. Folder/packer 312 may include sensors which may perform QC monitoring on the process.

Referring now back to FIG. 2, at 202, a dataset of records is created and/or accessed and/or provided. The records may be obtained from multiple different sample printing systems that have been set up with multiple different sample process parameters, that have printed on multiple different sample media, obtaining multiple different quality results. For example, after each printing session, a respective record is provided from the respective sample printing system for being added to the dataset, for example, as described with reference to 218. The dataset may be managed by a central server, that receives the records over a network from the different network connected printing systems.

The dataset may be implemented as, for example, a database.

Each record includes the following data elements (also referred to as data items):
(i) One or more sample media parameters of the sample media for processing and/or printing (i.e., that was processed and/or printed) thereon by the sample printing system. Examples of media include textile. Examples of media parameters include one or more properties of the textile. Examples of media parameters (which may be properties of the textile) include: chemistry of the fibers (e.g., cotton, polyester, blends, etc.), physical properties, absorption of ink, pretreatment, post treatment (e.g., performed on the fabric, softener, water repellent), topography, woven or non-woven, weaving pattern, knitting pattern, type (e.g., garment, fabric, t-shirt, hat, hoodie, shoe, upper part of shoe, and roll), width, material, physical dimensions, color, thickness, stretchability, manufacturer, supplier, and batch.

Optionally, for each garment, the record includes the following media parameters: barcode, garment type (e.g., shoe, upper part of shoe, shirt, roll, pants), default fabric, color list, garment size detail list, fabric (e.g., thickness, material), garment size details (e.g., width, height, commercial size, and print area layout), and print area layout (e.g., fabric, size (e.g., width, height).

In some embodiments, where the media is fabric, the media parameters are divided into a first group and a second group. The first group relate to the textile that made the media. This influences the print setup due to the chemistry of the textile. The second group relates to the physical properties of the media such as size of the rolls or garment. This influences the physical properties of the system to be adapt to the physical properties of the media.
(ii) An indication of a quality of the processing and/or the printing by the sample printing system set up with one or more sample process parameters. Quality include multiple sub-parameters, for example, defining quality of the different parts of the printing and/or processing, such as quality of the loading, correct selection of height of print head, any errors, and the like.

The quality may be, for example, a category (e.g., poor quality, low quality, medium quality, high quality, very high quality), a numerical scale (e.g., quality on a scale of 1-10), an indication (e.g., errors encountered, selected print head height not satisfactory). Quality may be obtained and/or computed, for example, automatically from a sensor(s) that senses a measurement indicating quality (e.g., wrinkles, loading parameters, and others described herein), comments from users, returns of printed media by customers, and manual feedback from operators.
(iii) A label indicating the sample process parameter(s). I.e., the sample process parameter(s) used to setup the sample printing system that printed on the sample media having the sample medial parameters (of (i)) and that obtained that quality (of (ii)). Exemplary process parameters include: physical printer setup, pallet automation for automatic selection and setting of a type of pallet (e.g., size of pallet, material of pallet, shape of pallet such as for a tee shirt, for a legging, and for a hoodie), print height, logical printer setup, pre-treatment, print speed, print resolution, and white underbase, drier temperature, and drying duration.

Process parameters may be defined for each component of the printing system, including the printer and/or other components, as described herein.

Each sample printing system includes a combination of a printer that prints on the media, and one or more other components: a loader mechanism that loads media into the printer, an unloader mechanism that unloads media from the printer, a drying system that dries the media after printing, a folding system that folds the media (after having been printed thereon), and a packing system that packs the media (after having been printed thereon). The other components are provided in addition to the printer, in order to process the media, in particular, to process fabrics and/or textiles, to provide pre-printing processing, processing during the printing, and post-printing processing, for example, to avoid wrinkles and/or as part of the process for printing on fabric and/or textiles. As discussed herein, such processing of fabrics and/or textiles is irrelevant to printing on other media such as paper, plastic, wood, and ceramic. The process parameters described herein may include a combination of a printer parameters for setting up the printer, and other processing parameters for setting up one or more of the other components, for example, loading parameters for setting up the loader mechanism, unloading parameters for unloading the unloading mechanism, dryer parameters for setting up the drying system, folding parameters for setting up the folding system, and packing parameters for setting up the packing system.

Process parameters may be related to special medial, for example, media load/unload strength/speed/grip, dryer temperature/duration, flatness/wrinkles limitations, and the like.

Process parameters may include print setup parameters for setting up the printer that prints on the media, for example, pretreatment temperature/duration/fluids volume, resolution, white under-base layer, single/double layer.

Exemplary media parameters may be for the actual media, for example, for a pallet type in order to fulfill the medial (e.g., standard, hoodies pallet, lady's size pallet), for a loader (e.g., gripper opening position, loading stroke), and for the unloader (e.g., gripping points, acceleration, speed). The media parameters for the pallet type may be used for automatic setup of the pallet.

Exemplary process parameters may be for processing of fabric, for example, fiber preparation parameters defining required setting to fulfill the fabric (e.g., heat, press, time), spray parameters defining the need spray setting for the fabric (e.g., spray amount, spray margins, whether spray is needed or not, wipe during spray, and number of cycles), and wiper parameters defining parameters that the wiper needs for the fabric (e.g., is wiping needed, wiper margins, and delay after spray).

The media parameter of (i) and/or the quality of (ii) may be automatically measured by one or more sensors associated with the respective printing system. Sensor(s) may measure, for example, thickness of the media, flatness of media, number and/or height of wrinkles, false loading and/or unloading procedure, bleeding of the print on the media, loading parameters, unloading parameters, overall processing time, overall print time, and false drying and/or curing process.

It is noted that the record may include additional dataset elements, as described herein, for example, a hardware type of the printing system.

Records may be created, for example, by extracting data from existing datasets and/or databases, manually entered by users, and/or automatically provided by printing systems based on actual print outcomes (e.g., as described with reference to 218).

Records with missing data items, for example, missing one or more of (i), (ii), and (iii) may be added. The data items may be missing entirely, and/or default values may be used rather than actual values obtained from printing sessions. For examples, for newly introduced media, the manufacturer of the media may create records with default values, until actual experience with the new media by actual printing systems provides real data. Such records with partial and/or default data may be used, for example, as a baseline, to train a machine learning model, to compute correlations, and the like. The blank data items may be filled in automatically as new data is obtained, and/or predicted by the trained ML model, and/or during iterative updates as described with reference to 220.

Data for the records may be obtained from different data sources. Some exemplary data sources are now described.

A supplier blank database, of the supplier that provided and/or manufactured the media, may be accessed. The supplier blank database stores the media blank properties from one or several suppliers of media. The supplier database provides values for the media parameters (i.e., i). These blank properties provide identification, for example, by the model's name, brand, and the fabric properties. These properties are blank specific (and sometimes manufacturer-specific) and not related to any specific textile printer. The supplier's media blank properties may be stored. The data from several suppliers is aggregated. The blank identification is provided together with the printing job parameters. The prints specific results from all printing systems (e.g., specific sensors, actions timing, QC results, etc.) for each print, may be provided.

Printing system sensors print data database may be accessed. The printing system sensors print data database provide values for the actual process parameters (i.e., iii). The actual printing parameters of different printing systems are collected and/or managed. This allows to make the connection between the blank used in the printing system and the actual printing instructions used to identify which were used and how many prints were produced and their end result quality, which is used for the quality grading.

A quality control (QC) dataset and/or customer return dataset and/or customer grades results dataset may be accessed. These datasets provide values for the quality (i.e., ii). The values of the dataset(s) may be obtained by automatic and/or manual measurements.

The data from the different sources are stored in the dataset as records, and used for preparing the quality grading and propose the recommended process parameters for a new blank, as described herein.

Referring now back to FIG. 4, record 400 may be created for a new media 402. Record 400 includes media attributes 404, also referred to herein as media parameters. Exemplary medial attributes 404 include print area, media (e.g., ID, type, size), and fabric (e.g., ID, material, thickness, color). Record 400 includes printer attributes 406, also referred to herein a process parameters. Exemplary printer attributes 406 include media print instructions (e.g., physical attributes such as pallet type, loading/unloading parameters, and the like) and fabric print (e.g., chemical attributes such as print height, pretreatment, resolution, white under-base, and the like). Record 400 includes print results 408, also referred to herein as quality. Exemplary print results 408 include media print results (e.g., loading, height, errors), and fabric print results (e.g., PQ/QC). Record 400 is used for optimization 410 of a current printing, as described herein.

Referring now back to FIG. 2, at 204, one or more machine learning (ML) models may be trained on the dataset, where label (i.e., data element iii) serves as a ground truth label.

The trained ML model receives an input of a combination of a target quality and one or more target media parameters (e.g., obtained as described with reference to 206), and generates an outcome of the target process parameters predicted to obtain the target quality.

The ML model may be implemented as, for example, a classifier, a statistical classifier, one or more neural networks of various architectures (e.g., convolutional, fully connected, deep, encoder-decoder, recurrent, graph, combination of multiple architectures), support vector machines (SVM), logistic regression, k-nearest neighbor, decision trees, boosting, random forest, a regressor and the like. The ML model may be trained using supervised approaches and/or unsupervised approaches.

At 206, a combination of a target quality and one or more target media parameters is obtained. The target quality and target media parameters are for a target printing system. For example, in the case of setting up the target printing system for printing on a new type of media for which the operator of the target printing system is unfamiliar, and is unsure of which target process parameters to use. The combination is provided, for example, in contrast to the operator performing multiple trial and error attempts, in which estimated process parameters are adjusted, in order to obtain the optimal process parameters, which is time consuming and wasteful of material, as described herein.

Target quality may be provided using different approaches, for example: provided by a user (e.g., manually entered by the operator using a user interface), automatically selected as a highest quality, a default fixed value (e.g., highest quality for client runs, or low quality for test runs), provided as metadata, and implied but not explicitly provided. As such, the target quality is not necessarily obtained from the printing system and/or operator. For example, when no target quality is obtained, the target quality may be set to a default, such as highest quality.

At 208, a combination of the target quality and the target media parameter(s) is assigned (e.g., mapped) to one or more target process parameters using the dataset and/or using the ML model trained on the dataset.

The assignment may be performed using different approaches. For example, when the ML model has been trained (e.g., as described with reference to 204), the combination of the target quality and the target media parameter(s) are fed into the trained ML model training. In another example, each record of the dataset may represent a point in a multidimensional space. For example, each data item (e.g., (i), (ii), (iii)) represents a dimensional axis, and the value of the respective data item represents a value along the respective dimensional axis. The target quality of the target media parameter are plotted as a target point within the space. A nearest point (denoting a certain record of the dataset) having a shortest Euclidean distance to the target point is found. The target process parameters are of the nearest found point. In another example, a correlation function computes correlations between the combination (of the target quality and the target media parameter(s)) and records of the dataset. The record having a highest correlation value is found. The assignment of the target process parameters is performed using the sample process parameters of the record with highest correlation value.

The assignment may be performed differently for different cases. For example:

When the target media parameter includes a unique identifier, the unique identifier of the target media parameter is matched with a unique identifier of the sample media parameter of a certain record of the dataset. The unique identifier may be a Global Trade Item Number (GTIN), can be also called “EIN”, which is a unique manufacturer identification format used by different media suppliers. The assignment of the target process parameters is performed using the sample process parameters of the certain record.

The approach described herein addressed the technical problem that arises when no GTIN is defined and/or available (e.g., some suppliers do not provide it for commercial reasons). In such a case, the other identification properties are used to recommend the closest setup for the media even without the GTIN so to allow to recommend, for example, an excellent printing system instructions for obtaining high quality prints.

When no match is found between the unique identifier of the target media parameter(s) and unique identifiers of records of the dataset, a similar record having sample media parameters that are statistically similar to the target media parameter(s) is found. Similarity may be found, for example, according to nearest points having shortest Euclidean distance within a multidimensional space, and/or using a correlation function (similar to an assignment approach descried herein). The assignment of the target process parameters is performed using the sample process parameters of the similar record.

Optionally, no specific media type is provided in the media parameter(s). For example, the operator of the target printing system wishes to know the best fabric to print on. In such a case, the target media parameter(s) indicate a requested print job without specifying the specific media. The label of the identified record of the dataset (e.g., nearest record, most similar record) may include the specific media type. The assigning is performed to the specific media type for printing the requested print job. The process parameters of the identified record for setting up the printing system for printing on the specific media type are provided.

At 210, the target process parameter assigned (e.g., mapped) in 208 may be provided. The printing outcome by the target printing system setup with the target process parameters, is predicted to obtain the target quality.

Optionally, the specific media type obtained in 208 is provided.

The target process parameter(s) may be provided to the target printing system, for example, as described with reference to 216. Alternatively or additionally, the target process parameters may be adapted, and/or locally and/or remotely processed, as described with reference to 214, for example, provided to another executing process on the same computing device (e.g., server), and/or provided to another computing device for remote processing.

At 212, the records of the dataset may be analyzed, for example, for performing big data analysis. It is noted that feature 212 may be performed independently of the flow described with reference to FIG. 2, for example, at any time, such as off-line, and/or in response to receiving one or more new records for updating the dataset.

Optionally, records are analyzed to understand how the media affects the printing quality. Correlations between media parameters and quality are computed for records of the dataset, for example, using a correlation function, and/or using a ML interpretability approach applied to the ML model (e.g., regression, Shapley values, LIME, and the like). The most significant media parameters that most impact target quality are found (e.g., having highest correlation values). Alternatively or additionally, records are analyzed to understand how process parameters affect quality. Correlations between process parameters and quality are computed for records of the dataset, for example, using a correlation function, and/or using a ML interpretability approach applied to the ML model (e.g., regression, Shapley values, LIME, and the like). The most significant process parameters that most impact target quality are found (e.g., having highest correlation values).

Other correlations between different data items may be computed, and the most significant data items that most impact other data items may be found.

The correlations and/or other analysis may be used to adapt the target process parameters, as described with reference to 214, and/or to adapt the sample process parameters.

At 214, the target process parameters may be adapted.

Adaptations may be computed, for example, when there is not exact match between received values (obtained as described with reference to 206), and a specific record of the dataset. For example, when multiple target media parameters are provided, and some sample media parameters of the matching record do not match.

Adaptations may be computed based on the correlations and/or other big data analysis described with reference to 212.

Adaptations may be done offline, to the sample process parameters of the records of the dataset, in addition to and/or instead of, adapting the identified target process parameters. Reference herein and below to adaptation of the target process parameter may refer alternatively, or additionally, to adaptation of the sample process parameters of the records of the dataset.

Optionally, when the target process parameter(s) is associated with a predicted quality below a threshold, the target process parameter(s) is adapted for predicting an increase in the target quality associated with the adapted target process parameter(s) to above the threshold. For example, when the target process parameter(s) are associated with a predicted quality of 7/10, which is below a quality threshold of 8/10, the target process parameter(s) may be adapted to predict an increase in the quality to 9/10. The adaptation may be performed, for example, based on computed correlations between process parameters and quality (e.g., computed as in 212).

When the specific printer hardware is not known, printer hardware may be considered for adjusting process parameters between different printers having different hardware. The sample process parameters of records of the dataset may include hardware parameter(s) of the sample printing system, for example, manufacturer, model, firmware, specific parts, and the like. The identified target process parameters may include hardware parameter(s) of the target printing system. When the hardware parameter(s) of the target printing system is different from the hardware parameter(s) of the sample printing system, the target process parameters may be computed from the sample process parameters. The computation may be according to, for example, a calibration function and/or a conversion function that calibrates and/or converts between hardware of the target printing system and hardware of the sample printing system. The sample process parameters may be adapted using the calibration and/or conversion function to compute the target process parameters for the different printer.

Alternatively or additionally, target process parameters and/or the sample process parameters may be adapted, for example, based on a set of rules, another trained ML model and/or other code trained to perform the adaptation, and the like.

Alternatively or additionally, target process parameters and/or the sample process parameters may be adapted, based on the analysis (e.g., correlations, or other big data analysis) performed as described with respect to 212. For example, when the analysis (e.g., correlations, or other big data analysis) identifies a media with high rate of failure (i.e., in view of other media) in the load and/or unloading process, the speed of the loading is adapted, and/or the pallet type is adapted. The adaptation will lead to better setup for this media and will continue to improve if needed. In another example, when the analysis (e.g., correlations, or other big data analysis) identifies media (in view of other media) with issues of print quality, the pre-treatment process parameters may be adapted. For example, for bleeding of the ink, the adaption is for increasing the pretreatment. For low wash fastness, or hand feel, the adaption is for reducing the pretreatment. The adaptation may include adding delays between layers. Yet another option of adaptation is to add or adapt physical pretreatment to the substrate such as heat press or hot air (if possible and existing in the printing system). Another option is to notify the operator of possible problem(s) with the specific printer, especially if the same media gives better results with the same parameters but in other printing system. Then the system can be calibrated, manually or automatically.

Alternatively or additionally, instructions indicating a recommendation for adapting the target process parameters are generated, for example, presented to a user on a display, played on audio speakers, or as code for automatically performing the adaptation optionally in response to user permission. For example, instructions for suggesting an adaptation to the process parameters corresponding to the identified most significant process parameters for improving the target quality (e.g., as described with reference to 212) may be generated. In another example, instructions for suggesting an adaptation to the target media parameter(s) corresponding to the identified most significant media parameters for improving the target quality (e.g., as described with reference to 212), may be generated.

Some exemplary adaptations are now described:
Physical size of the media substrate. The garment size and/or type may need a different pallet (and/or adaptation of the pallet when possible) for loading the garment into the printer. Fabric size might require changes in the parameters for the loader of the printer.
Thickness. The printing system may need to adapt the height of the print-head to the upper side of the garment to prevent collision and contact between the garment being printing and the print-head (e.g., between 2-4 millimeter (mm)). In screen printing also may also be a need to adapt the gap between the screen and the upper side of the garment/fabric.
Stretchability. In fabric printing the stretchability of the fabric may require a different setup of the loading and conveying system to prevent movement and/or to provide accurate movement of the fabric.
Loading. Physical parameters may also be used to adapt the parameters of the loading (e.g., made by full automation or assisted by automation) such as the velocity of loading without disturbing the loaded garment on the pallet, the pulling force needed to flatten the garment, etc.
Pretreatment. The printing system might need to adapt the pretreatment (sometime this step is done on the printer or offline). Pretreatment might require adaptation in the color profile both for the white under-base and the colors as well depending on all the parameters of the garment/fabric. The pretreatment may be a liquid to be deposed on the garment and/or might require to be dried and/or cured before printing thereon. The adaptation might be the quantity needed of the pretreatment and/or the drying/curing process.

The pretreatment might be adapted to include only physical treatment such as heat.
Printing parameters. Delays between pretreatment (if any) and printing, and/or delay between layers of white and/or between white and colors, may be adapted accordingly.
Ink. Printing additional inks such as adhesion promoters/cross-linkers/softeners depending on the substrates needs to improved final properties.
Color of the garment. White garment does not necessarily require any white under-base. In light colors garment the white layer can be thin versus thick for dark garment. This parameter can also lead to optional “delete” of the part where the design to print color is equal to the garment.

At 216, instructions for processing and/or printing on the target media by the target printing system setup using the target process parameters are generated. The instructions may be generated, for example, by the target printing system itself, and/or by a controller associated with the target printing system, for example, a control panel on the target printing system, a client terminal communicating with the target printing system via a wired connection and/or network connection, a mobile device communicating with the target printing system via a wireless connection, and the like.

Optionally, the instructions are for automatic setup of the pallet type used for printing on the target media by the target printing system. The automatic printing pallet may be set to the correct configuration during the print preparation process as part of the specific job instructions. For example, if the next print job is on a small tee shirt with neck-tag print, the instructions are for automatically changing the pallet configuration to a small pallet with optional neck-tag printing. The pallet type may be dynamically adapted for different printing jobs.

The target printing system setup with the target process parameters may process and/or print on the target media.

At 218, the dataset may be updated with a new record. The new record may be created from data of the printing and processing described with reference to 216 using the target process parameter. Alternatively or additionally, the new record may be created in response to any printing and processing done by the printing system, using process parameters which are not necessarily obtained using the dataset, for example, manually selected by an operator, or preset default values. Alternatively or additionally, data items of an existing records are adapted to create the new record, for example, where the data items are incorrect, have changed, or better values that provide better results are obtained.

The newly created record may include: (i) actual media parameter(s) of actual media printed thereon by an actual printing system, (ii) the indication of the actual quality of the actual media processed and printed thereon by the actual printing system setup with actual process parameter(s), and (iii) the label indicating the actual process parameter(s).

The actual process parameters of the new record, used to set up the actual printing system, may be obtained by using the printing dataset for mapping the combination of a certain quality and the actual media parameters, as described herein. Alternatively or additionally, the actual process parameters of the new record were obtained using other approaches, for example, manually entered by an operator, and/or using preset default values.

The new record is added to the dataset to create an updated dataset. The updated dataset is used for performing the assigning for new media parameters, as described herein.

Referring now back to FIG. 2, at 220, one or more features described with reference to 202-216 may be iterated, for example, in order to improve quality of a print jobs by one or more printing systems, in order to improve quality of a specific print job, and/or in order to fine tune the dataset. The iterations may provide close loop optimization. The iterations may be performed to fine-tune the trained ML model, for improving accuracy of the ML model in generating the process parameters that provide the desired quality, for example, for providing high quality print job outcomes. The iterations may be an adapted form of A/B testing, or other approaches.

For example, in one or more iterations, the following are performed: A certain combination of a certain quality and a certain media parameter(s) of a certain media, is fed into the ML model. An outcome of process parameters is obtained from the ML model. One or more variations of the outcome are generated by adapting at least one of the process parameters. The adaptation may be performed, for example, using the computed correlations (e.g., in an attempt to increase quality), randomly, sequentially, based on manual user input, or other approaches. Multiple printed samples are created by printing and processing the certain media. Each printed sample is printed and processed by the printing system set up with a respective variation of the outcome. Alternatively or additionally, multiple printed samples are printed and processed by multiple printing systems set up with respective variations. A respective indication of quality is assigned to each printed sample. Multiple new records are created and/or data items of existing records are adapted. Each record includes a respective variation, and corresponding quality. An updated version of the ML model, created by updating with the new and/or adapted records, is created. The updated version of the ML model may be used during subsequent iterations and/or assignments.

In an exemplary, the same garment is printed on multiple times, each time at a different location using a variation of the process parameters, for iterative improvement. An exemplary approach is now described. Create a file with different Known LAB patches—Pure C M Y K R G W and few selected mixed combination. Print on the same shirt 4\6 (or other number) times with a different setup (find the “closer” setups for this fabric based on known parameters). The difference in the setups Could be: Fixa and FOF amount, Different max white and whiteness. Check visually to find the best (Pass\fail). Measure the patches and compare the known LAB of the reference, manually and/or automatically. Assign the best setup (out of this 4\6) to the fabric in the dataset.

Examples of how the iterations provide improvement (e.g., higher print quality and/or less printing and/or processing time) are now provided.

### EXAMPLE 1—MEDIA HEIGHT

The media height (e.g., shirt width) has a very significant influence on the printing system process since it defines the print-head's height above the media, which in turn controls the accuracy of the ink laydown on the printed media. A correct media height is a prerequisite for any high quality print.

In a first iteration, the media of a specific and well-marked garment (e.g., with a unique catalog number in the dataset) height is first defined with a default value (e.g., about 2 mm) which allows acceptable print quality. However, after analyzing the result's quality and the media behaviour, this parameter can then be optimized by the printer's on-board laser based media height device, so that the value is corrected (e.g., to 3 mm) and by that the print quality is improved (by more accurate ink laydown) from the next shirt on. The updated results, including the corrected height value, and the improved quality, are used to update the records of the dataset, for example, as a new record and/or adaptation of the existing record. Furthermore, since the dataset may be global, any other printing systems that uses the same media parameters can benefit from the updated data and use the corrected parameter.

### EXAMPLE 2—FABRIC TYPE

The fabric type and material (cotton, polyester, blend, etc.) of the printed garment determine many parameters in the printing system, such as fixation fluids and ink type and amounts, print height, pretreatment parameters (heat, pressure, time) and more. Since there are default parameters to define all fabric types that are used by all the garments manufacturers, almost each garment should be defined as a unique media with its specific attributes.

The basic attributes are defined as defaults in the dataset, and the iterations enable the end results to refine the data by each print until the optimized parameters are found. The data loop is closed by the quality results (e.g., as defined by the manufacture QC, either manually or automatically), by the loading time, etc., The default parameters (e.g., amount of fixation fluid, preheat temperature, etc.) are updated accordingly.

### EXAMPLE 3—AUTOMATION

Every media size, kind, material might require different preparation and parameters for the loading/unloading on the pallet as well as of the pallet itself.

Referring now back to FIG. 5, the process described with reference to FIG. 5 may be implemented using features described with reference to FIG. 2. At 502, a new media for which process parameters are needed is provided. At 504, the dataset is accessed to determine whether media attributes (i.e., media parameters) exist for the new media. At 506, when media attributes exist, the new media is added to existing media. At 508, existing printing instructions (i.e., process parameters) are allocated (e.g., assigned and/or mapped) to the new media.

At 510, the dataset is accessed to determine whether fabric attributes exist for the new media. At 512, when fabric attributes exist, the new media is added to existing fabrics. At 514, existing printing instructions (i.e., process parameters) are allocated (e.g., assigned and/or mapped) to the new media.

Alternatively to 504 and 510, at 516, when the new media does not exist in the dataset, the new media is added, optionally as a new record. At 518, new printing instructions (i.e., process parameters) are compiled. At 520, test print samples may be generated, and the dataset is updated accordingly, for example, in an iterative data optimization stage.

Referring now back to FIG. 6, the process described with reference to FIG. 6 may be implemented using features described with reference to FIG. 2.

At 602, existing records of the dataset (i.e., media records) are provided. Each record includes media attributes and/or fabric attributes (i.e., media parameters), print instructions for setup of the printing system (i.e., process parameters), and media and fabric grades (i.e., quality).

At 604, do the media and fabric grades meet QC requirements?

At 606, when the answer to 604 is yes, existing process parameters are allocated.

At 608, the print job is sent for execution by the printing system.

Alternatively, at 610, when the answer to 604 is no, new process parameters are complied.

At 612, test samples are printed on the printing system. The printed samples and/or the printing system's sensors are checked.

At 614, the best setup is selected, and the process parameters are updated.

At 616, the printing system\s sensor(s) outputs are analyzed. The quality is updated.

Referring now back to FIG. 7, the dataflow described with reference to FIG. 7 may be implemented using features described with reference to FIG. 2 and/or using components of the system described with reference to FIG. 1.

One or more different manufacturers 702 provide media parameters (e.g., GTIN), manually and/or automatically, for creating records of a dataset 704 (also referred to as main media database). A big data analysis 706 may be performed using the data of the records (e.g., media parameters, process parameters, quality, and/or other data), as described herein. For example, to provide overall media grading (i.e., quality). A printing system(s) 708, which includes a printer and other components such as a dryer, receives job instructions (i.e., process parameters) based on media parameters, from dataset 704. For example, to print test samples. The outcome of the printing (e.g., sensor outputs, QC) may be analyzed 710, for example, to determine specific media grading (i.e., quality). Records of dataset 704 are updated with the determined quality for the printing job.

Referring now back to FIG. 8, exemplary media parameters visually depicted in a polo shirt 802 include: media type (e.g., shirt/pants/hat/shoe etc.), media size (e.g., width, height), media default thickness, and media printing areas. For each printing area, the following may be defined: fabric type (e.g., Polyester/Cotton/Blend), fabric thickness, fabric Color, print area size, and print area location. One print area 804 is marked for clarity.

Referring now back to FIG. 9, the process described with reference to FIG. 9 may be implemented using features described with reference to FIG. 2 and/or using components of the system described with reference to FIG. 1. At 902, a media definition is provided (e.g., media type, name, size, manufacturer, and printing areas). At 904, fabric definition and/or assignment from existing data is done (e.g., color, type, thickness). At 906, fulfilment definition on the printing system is done (e.g., media fulfilment parameters, fabric fulfilment parameters).

Referring now back to FIG. 10, tree 1002 indicates exemplary media parameters and one or more levels of sub-parameters, such as for different print areas. For example, media ID, name, size, media type, default fabric (e.g., fabric identifier, thickness, material, color), and print areas. The following are exemplary parameters for each print area: print area ID, name, fabric (e.g., ID, thickness, material, color, media darkness), size (e.g., length, width), angle, offset point, and print area side).

Referring now back to FIG. 11, tree 1102 indicates exemplary print sections—the images and areas that the current print job is built from. A print section list includes a print section number. The print section number includes, for example, a print selection ID, offset position, size, is section printed, and list of job layers. Each job layer number includes, for example, Layer Identifier—from print head configuration to connect the nozzle rows printed on this layer, job layer identifier, name, max print height, number of repeats, print quality, and list of separation data. Exemplary parameters of the print quality include: Layer Pass Type-none, single, double (might not be needed after ne dynamic print sequence, Print Direction-Both Directions, Forward Direction, Backward Direction, Illegal Direction, is uni-directional, Print Mode-which separation will be printed: cmyk, cmykw, . . . ) (might not be needed after ne dynamic print sequence, Print Speed-High Production, Production, High Quality, Delay Between Layers, and Coverage Factor. Exemplary list of separation data include: Name—the names of all the separation that will be printing on this area, Separation Location—the path to the one bit.

Referring now back to FIG. 12, tree 1202 indicates an exemplary fulfilment data model (for each printing system and configuration) indicating exemplary process parameters. Exemplary fulfilment settings include medial related printing system fulfilment settings, and fabric related printing system fulfilment settings. Exemplary media related settings include: media identifier, loader properties (e.g., gripper location, loading margin), unloader properties (e.g., acceleration, speed, location), and supported surface. Exemplary fabric related settings include: fabric identifier, spray settings (e.g., is spraying, fixation percentage, number of spray cycles, and spray margins such as vertical and horizontal), fiber preparation properties (e.g., temperature, pressure, time), and wipe properties (e.g., is wiping, wipe during spray, and wipe margins such as front and back).

Referring now back to FIG. 13, shirt 1302 includes four different test print runs 1304A-D, each printed using a variation of a set of process parameters, for iterative improvement, for example, as described with reference to 220 of FIG. 2.

Exemplary parameters for a print job include:
Identification Details: Job ID, Job Name, Job Path
List of Images (when Image is: ) Physical Print Info (e.g., Position (offset X & Y), Width, Height), Selected print area, Should be printed, Print quality per layer (e.g., Quality, TPT, CPP), and x & y resolution.
Number of copies
Media, for example, Barcode

Another example of parameters for a print job include:
Identification Details: Job ID, Job Name, Job Path
Physical Print Info
Physical Print Info (e.g., Position (offset X & Y), Width, Height)
Media, for example, Barcode
Print properties, for example, Max print height
Print Quality Per Layer, for example: Layer pass type (none, single, double), Print direction (Both Directions, Forward Direction, Backward Direction, Illegal Direction), Print mode (which separation will be printed: cmyk, cmykw, . . . ), Print speed (High Production, Production, High Quality), Delays between layers, and x & y Resolution.

Yet another example of parameters for a print job include:
Identification Details—Cannot be changed (create a new job for that), for example, Job Identifier—unique Guid number for each job, and Job Name
Insertion Time
Total Copies
Number Of Left Copies
Sequence Identifier—each job has sequence of actions to perform for printing this job
Job Category—job service support many kind of categories for job queue: regular, hot folder, calibration etc. For example, Job Category Identifier, Category Name, and Priority
Media Identifier—unique Guid number for each media
Name
Size
Media Type—shirt, pants etc.
Default Fabric—default for all this media, otherwise, each print area has its own special fabric,
For each fabric: Fabric Identifier—unique Guid number for each fabric, Thickness, Material, Color.
List of Print Areas—all the areas on this media that we can print on them. For each area: Print Area Identifier—unique Grid number for each print area, Name, Fabric (Fabric is an entity that should be stored in a DB and has thickness, material and color), Size—the size of the rectangle, Angle—the angle this rectangle has from the offset point, Offset Point—starting point of this rectangle on all this media, Print Area Side
front or back—for future use.
Print Section Identifier—unique Guid number for each print section
Offset Position
Size
Is Section Printed—update this property to true when this section is printed
List of Job Layers. For each layer: Layer Identifier—from print head configuration to connect the nozzle rows printed on this layer, Job Layer Identifier, Name, Max Print Height, Number Of Repeats, Print Quality—including: Layer Pass Type—none, single, double (might not be needed after ne dynamic print sequence, Print Direction—Both Directions, Forward Direction, Backward Direction, Illegal Direction, Is Uni-Direction Print Mode—which separation will be printed: cmyk, cmykw, . . . ) (might not be needed after ne dynamic print sequence, Print Speed—High Production, Production, High Quality, Delay Between Layers, Resolution, Coverage Factor
List of Separation Data, for example, Name—the names of all the separation that will be printing on this area, Separation Location—the path to the one bit

Referring now back to FIG. 14, the table includes exemplary media parameters 1402, fields 1404, and examples/units 1406.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant printing systems will be developed and the scope of the term printing system is intended to include all such new technologies a priori.

As used herein the term “about” refers to +10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of setting up a target printing system for printing on a target media, comprising:
providing a dataset of a plurality of records, wherein a record comprises:
(i) at least one sample media parameter of a sample media for processing and/or printing thereon by a sample printing system,
(ii) an indication of a quality of a processing and/or a printing by the sample printing system set up with at least one sample process parameter, and
(iii) a label indicating the at least one sample process parameter;
assigning using the dataset, a combination of a target quality and at least one target media parameter, to at least one target process parameter; and
providing the at least one target process parameter predicted to obtain the target quality, for generating instructions for processing and/or printing on the target media by the target printing system.

2. The computer implemented method of claim 1, wherein the printing system includes a combination of a printer and at least one of a loader mechanism that loads media into the printer and/or an unloader mechanism that unloads media from the printer and/or a drying system and/or folding and/or packing system, wherein the target process parameters include a combination of a plurality of printer parameters for setting up the printer, and at least one of loading parameters for setting up the loader mechanism and unloading parameters for unloading the unloading mechanism.

3. The computer implemented method of claim 1, wherein the target media comprises textile, and the at least one target media parameter comprises at least one property of the textile.

4. The computer implemented method of claim 3, wherein the at least one property of the textile is selected from a group comprising: garment, fabric, t-shirt, hat, hoodie, shoe, upper part of shoe, and roll.

5. The computer implemented method of claim 1, further comprising:
creating a new record comprising:
(i) at least one actual media parameter of actual media printed thereon by an actual printing system,
(ii) the indication of the actual quality of the actual media processed and printed thereon by the actual printing system setup with the at least one actual process parameter, and
(iii) the label indicating the at least one actual process parameter;
adding the new record to the dataset to create an updated dataset; and
using the updated dataset for performing the assigning for new media parameters.

6. The computer implemented method of claim 5, wherein the actual process parameters of the new record, used to set up the actual printing system, are obtained by using the printing dataset for mapping the combination of a certain quality and the actual media parameters.

7. The computer implemented method of claim 1, wherein the target quality is at least one of: provided by a user, automatically selected as a highest quality, a default fixed value, provided as metadata, and implied but not explicitly provided.

8. The computer implemented method of claim 1, further comprising: when the at least one target process parameter is associated with a predicted quality below a threshold, adapting the at least one target process parameter for predicting an increase in the target quality associated with the adapted at least one target process parameter to above the threshold.

9. The computer implemented method of claim 1, further comprising:
analyzing the dataset for computing correlations between media parameters and quality;
identifying most significant media parameters that most impact target quality; and
generating instructions for suggesting an adaptation to the at least one target media parameter corresponding to the identified most significant media parameters for improving the target quality.

10. The computer implemented method of claim 1, further comprising:
analyzing the dataset for computing correlations between process parameters and quality;
identifying most significant process parameters that most impact target quality; and
generating instructions for suggesting an adaptation to the process parameters corresponding to the identified most significant process parameters for improving the target quality.

11. The computer implemented method of claim 1, wherein the plurality of sample process parameters of records of the dataset comprise at least one hardware parameter of the sample printing system, and the at least one target process parameters comprise at least one hardware parameter of the target printing system, and further comprising: when the at least one hardware parameter of the target printing system is different from the at least one hardware parameter of the sample printing system, generating the at least one target process parameters from the plurality of sample process parameters according to at least one of a calibration function and/or a conversion function, between hardware of the target printing system and hardware of the sample printing system.

12. The computer implemented method of claim 1, wherein at least one of: (i) the media parameter, and (ii) the quality, obtained by implementing the target process parameters, are automatically measured by at least one sensor associated with the target printing system, wherein the at least one sensor measures at least one of: thickness of the media, flatness of media, number and/or height of wrinkles, false loading and/or unloading procedure, bleeding of the print on the media, and false drying and/or curing process.

13. The computer implemented method of claim 1, wherein assigning comprises at least one of:
(i) feeding the combination of the target quality and the at least one target media parameter into a machine learning model training on the dataset, wherein the label of the dataset comprises a ground truth label, and
(ii) computing a shortest Euclidean distance within a multidimensional space, between a point represented by the target quality and the at least one target media parameter and a nearest point denoting a certain record of the plurality of records, wherein the at least one target process parameters are of the nearest point.

14. The computer implemented method of claim 1, wherein the at least one target media parameter and the at least one sample media parameter are selected from a group comprising: chemistry, physical properties, absorption of ink, pretreatment, post treatment, topography, woven or non-woven, weaving pattern, knitting pattern, type, width, material, physical dimensions, thickness, stretchability, manufacturer.

15. The computer implemented method of claim 1, wherein the at least one target process parameter and the at least one sample process parameter are selected from a group comprising: physical printer setup, pallet automation for automatic selection and setting of a type of pallet, print height, logical printer setup, pre-treatment, print speed, print resolution, and white underbase, drier temperature, drying duration.

16. The computer implemented method of claim 1, wherein the at least one target media parameter comprises a unique identifier, assigning comprises matching the unique identifier of the at least one target media parameter with a unique identifier of the at least one sample media parameter, and when no match is found between the unique identifier of the at least one target media parameter and the unique identifier of the at least one sample media parameter, assigning comprises identifying at least one sample media parameter that is statistically similar to the at least one target media.

17. The computer implemented method of claim 1, wherein the label of the record of the dataset is for a specific media type, wherein assigning comprises assigning the combination of the target quality and the at least one target media parameter indicating a requested print job to the specific media type, and providing further comprises providing the specific media type for printing the requested print job.

18. A system for setting up a target printing system for printing on a target media, comprising:
a server in network connection with a plurality of printers, the server comprising at least one hardware processor executing a code for:
accessing at least one target media parameter associated with a target printer of the plurality of printers;
assigning a combination of a target quality and at least one target media parameter, to a plurality of target process parameters, using a dataset comprising a plurality of records obtained from a plurality of sample printers, wherein a record comprises:
(i) at least one sample media parameter of a sample media for processing and printing thereon by a sample printing system,
(ii) an indication of a quality of a processing and a printing by the sample printing system set up with a plurality of sample process parameters, and
(iii) a label indicating the plurality of sample process parameters; and
providing the plurality of target process parameters predicted to obtain the target quality, for generating instructions for processing and printing on the target media by the target printing system.

19. A computer implemented method of training a machine learning model for generating a plurality of target process parameters for setting up a target printing system for printing on a target media, comprising;
creating a dataset of a plurality of records, wherein a record comprises:
(i) at least one sample media parameter of a sample media for processing and printing thereon by a sample printing system,
(ii) an indication of a quality of a processing and a printing by the sample printing system set up with a plurality of sample process parameters, and
(iii) a ground label indicating the plurality of sample process parameters;
training the machine learning model on the dataset for receiving an input of a combination of a target quality and at least one target media parameter, and generating an outcome of the plurality of target process parameters predicted to obtain the target quality,
wherein instructions are generated for processing and printing on the target media by the target printing system set up using the plurality of target process parameters.

20. The computer implemented method of claim 19, further comprising, performing at least one iteration of:
feeding a certain combination of a certain quality and a certain plurality of media parameters of a certain media;
obtaining an outcome of the plurality of process parameters;
creating at least one variation of the outcome by adapting at least one of the plurality of process parameters;
printing and processing a plurality of printed samples of the certain media, each printed sample is printed and processed by the printing system set up respectively with the at least one variation of the outcome, or by a plurality of printing systems set up with respective variations;
assigning a respective indication of quality to each printed sample;
creating a plurality of new records, each record including respectively the at least one variation, and respective quality; and
using an updated version of the ML model updated with new records during a next iteration.
